(19) United States
(12) Patent Application Publication
(10) Pub. No.: US 2026/0032465 A1
(43) Pub. Date: Jan. 29, 2026

(54) Transmitter Node, Receiver Node and Methods for Adapting Signal Processing Capability of a Receiver

(71) Applicant: Telefonaktiebolaget LM Ericsson (publ), Stockholm (SE)

(72) Inventors: Hamed Farhadi, Stockholm (SE); Qiang Zhang, Täby (SE); David Sandberg, Sundbyberg (SE); Mårten Sundberg, Årsta (SE)

(21) Appl. No.: 18/997,609

(22) PCT Filed: Jul. 27, 2022
(86) PCT No.: PCT/SE2022/050730

§ 371 Date: Jan. 22, 2025

(51) Int. Cl. H04W 24/02; G06N 3/082; H04L 1/00

(52) U.S. Cl. CPC H04W 24/02; G06N 3/082; H04L 1/0045

(57) ABSTRACT

Embodiments herein relate to, for example, a method performed by a transmitter node (12) for adapting a signal processing capability of a receiver of a receiver node (10) in a communication network (1). The transmitter node (12) obtains an estimated signal quality of a signal, an indication of a hardware quality, a status of an energy source associated with the receiver, and/or a target KPI. The transmitter node (12) further initiates an adaption of the signal processing capability of the receiver based on the estimated signal quality, the indicated hardware quality, the status of the energy source, and/or the target KPI.

### TECHNICAL FIELD

Embodiments herein relate to a transmitter node, a receiver node and methods performed therein regarding communication. Furthermore, a computer program product and a computer-readable storage medium are also provided herein. In particular, embodiments herein relate to handling communication, such as handling or controlling configurations at a receiver of the receiver node, in a communications network.

### BACKGROUND

In a typical wireless communications network, user equipments (UE), also known as wireless communication devices, mobile stations, stations (STA) and/or wireless devices, servers, computers, communicate via an Access Network (AN), such as a radio access network (RAN) or a wired access network, with one or more core networks (CNs). The AN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The access node operates on radio frequencies to communicate over an air interface with the UEs within range of the access node. The access node communicates over a downlink (DL) to the UE and the UE communicates over an uplink (UL) to the access node.

Machine learning (ML) algorithms refer to techniques that use a set of data for training models and the models are used for various applications including inference, classification, prediction. The ML algorithms may be classified into online and offline algorithms, where the offline algorithms are relying on pre-trained models while the online algorithms can train the model on the fly while receiving new data samples.

A receiver is used herein in a broad meaning, referring to an entity that receives certain transmitted data. The data can be transmitted e.g., over a wireless channel, through an optical fiber, or through a wired channel, e.g., for asymmetric digital subscriber line (ADSL) communication. Common to all receivers is that they will experience conditions over time and/or frequency and/or space that are unknown and need to be estimated to achieve optimal performance. These conditions can also vary, over e.g., time or frequency. Under each condition, the receiver can possibly operate in different ways.

ML and/or artificial intelligence (AI) receiver methods may be used at the receiver side to optimize one or multiple functionalities at the receiver. For example, a machine learning receiver method is proposed in H. Farhadi and M. Sundberg, “Machine learning empowered context-aware receiver for high-band transmission,” IEEE Globecom Workshops, 2020 to optimize the demapper, a single functionality, to compensate the hardware impairments due to oscillator phase noise.

FIG. 1 shows a receiver chain with an example of a single functionality (the soft demapper) replaced by machine learning, as in for example, H. Farhadi and M. Sundberg, “Machine learning empowered context-aware receiver for high-band transmission,” IEEE Globecom Workshops, 2020.

Furthermore, adaptive methods for iterative error correcting decoders have been proposed in the literature to reduce complexity. A low-density parity check (LDPC) decoding method that sets a maximum number of decoding iterations based on estimated SNR is proposed in KR20030016720A. A turbo decoding method that dynamically adapts the number of iterations based on estimate of SNR is proposed in CN102420671A, and a turbo decoding of a plurality of radio channels performing cyclic redundancy check (CRC) at the end of each iteration is proposed in EP1249958A1.

### SUMMARY

As part of developing embodiments herein one or more problems were first identified. Baseline receiver methods, e.g., as the neural network-based demapper in H. Farhadi and M. Sundberg, “Machine learning empowered context-aware receiver for high-band transmission,” IEEE Globecom Workshops, 2020, have fixed complexity which does not depend on either the signal quality or hardware quality. Therefore, the processing delay is fixed regardless of the quality of the received signal or the level of distortions due to hardware impairments, such as phase noise. This causes low energy efficiency at the receiver and high expected latency for signal processing at the receiver. The low energy efficiency of the receiver causes short battery lifetime of the receiver nodes in downlink scenarios and increases in size and weight in uplink scenarios.

An object herein is to provide a mechanism to handle communication efficiently in the communication network.

According to an aspect the object is achieved, according to embodiments herein, by providing a method performed by a transmitter node for adapting a signal processing capability of a receiver of a receiver node in a communication network. The transmitter node obtains an estimated signal quality of a signal, an indication of a hardware quality, a status of an energy source associated with the receiver, and/or a target key performance indicator (KPI). The transmitter node further initiates an adaption of the signal processing capability of the receiver based on the estimated signal quality, the indicated hardware quality, the status of the energy source, and/or the target KPI.

According to another aspect the object is achieved, according to embodiments herein, by providing a method performed by a receiver node for adapting a signal processing capability of a receiver comprised in the receiver node in a communication network. The receiver node obtains an estimated signal quality of a signal, an indication of a hardware quality, a status of an energy source associated with the receiver, and/or a target KPI. The receiver node further adapts the signal processing capability of the receiver based on the estimated signal quality, the indicated hardware quality, the status of the energy source, and/or the target KPI.

According to yet another aspect the object is achieved, according to embodiments herein, by providing a radio network node and UE configured to perform the methods, respectively.

Thus, according to still another aspect the object is achieved, according to embodiments herein, by providing a transmitter node for adapting a signal processing capability of a receiver of a receiver node in a communication network. The transmitter node is configured to obtain an estimated signal quality of a signal, an indication of a hardware quality, a status of an energy source associated with the receiver, and/or a target KPI. The transmitter node is further configured to initiate an adaption of the signal processing capability of the receiver based on the estimated signal quality, the indicated hardware quality, the status of the energy source, and/or the target KPI.

According to yet another aspect the object is achieved, according to embodiments herein, by providing a receiver node for adapting a signal processing capability of a receiver comprised in the receiver node in a communication network. The receiver node is configured to obtain an estimated signal quality of a signal, an indication of a hardware quality, a status of an energy source associated with the receiver, and/or a KPI. The receiver node is further configured to adapt the signal processing capability of the receiver based on the estimated signal quality, the indicated hardware quality, the status of the energy source, and/or the target KPI.

It is furthermore provided herein a computer program product comprising instructions, which, when executed on at least one processor, cause the at least one processor to carry out the methods herein, as performed by the transmitter node and receiver node, respectively. It is additionally provided herein a computer-readable storage medium, having stored thereon a computer program product comprising instructions which, when executed on at least one processor, cause the at least one processor to carry out the methods herein, as performed by the transmitter node and the receiver node, respectively.

Embodiments herein disclose ways to adapt the receiver's signal processing capability, e.g., a size of neural network model, according to one or more of: the estimated signal quality, for example, measured using e.g. SNR; the hardware quality, for example, measured using the level of hardware impairments e.g. phase noise power; estimated receiver's energy status, for example, measured battery status; and the target KPI, for example measured processing delay, to be fulfilled to improve energy efficiency and reduce average processing delay. Thus, embodiments herein handle communication efficiently in the communication network.

### BRIEF DESCRIPTION OF THE DRAWINGS

Embodiments will now be described in more detail in relation to the enclosed drawings, in which:

FIG. 1 shows a receiver chain with an example of a single functionality according to prior art;

FIG. 2 shows a communication network according to embodiments herein;

FIG. 3 shows a combined signalling scheme and flowchart according to embodiments herein;

FIG. 4 shows a combined signalling scheme and flowchart according to embodiments herein;

FIG. 5 shows a combined signalling scheme and flowchart according to embodiments herein;

FIG. 6 shows a flowchart depicting a method performed by a transmitter node according to embodiments herein;

FIG. 7 shows a flowchart depicting a method performed by a receiver node according to embodiments herein;

FIG. 8 shows a combined signalling scheme and flowchart according to embodiments herein;

FIG. 9 shows a combined signalling scheme and flowchart according to embodiments herein;

FIG. 10 shows a schematic block diagram depicting a method performed in a receiver node according to some embodiments herein;

FIG. 11 shows a schematic overview depicting a method for NN model selection according to some embodiments herein;

FIG. 12 shows a schematic overview depicting a method for NN model selection according to some embodiments herein;

FIG. 13 shows a schematic overview depicting a method for NN model selection according to some embodiments herein;

FIGS. 14a-b show schematic overviews depicting a transmitter node according to embodiments herein;

FIGS. 15a-b show schematic overviews depicting a receiver node according to embodiments herein;

FIG. 16 schematically illustrates a telecommunication network connected via an intermediate network to a host computer;

FIG. 17 is a generalized block diagram of a host computer communicating via a base station with a user equipment over a partially wireless connection; and

FIGS. 18-21 are flowcharts illustrating methods implemented in a communication system including a host computer, a base station and a user equipment.

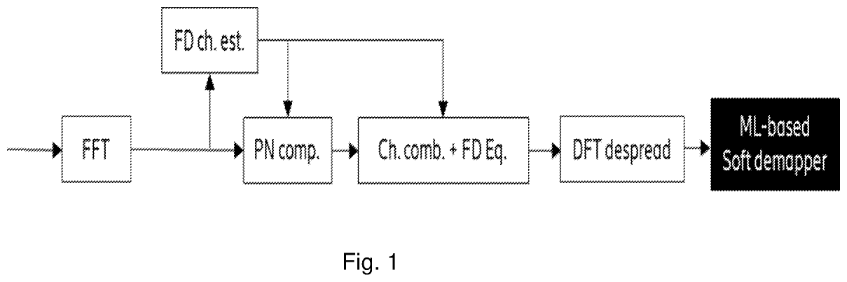

### DETAILED DESCRIPTION

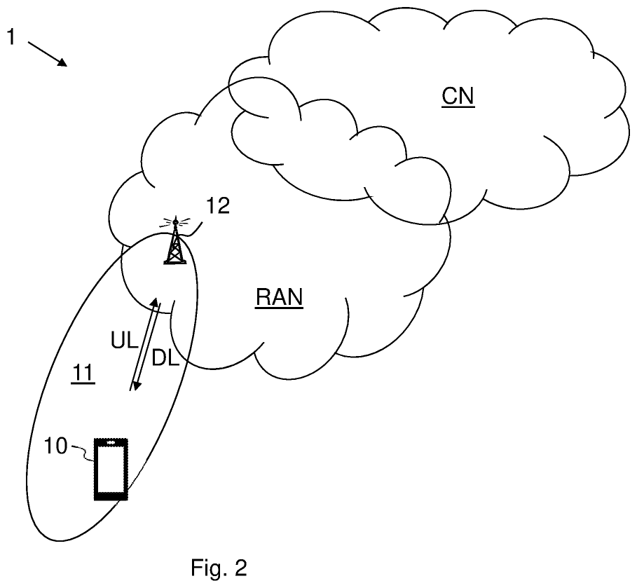

Embodiments herein relate to communication networks in general. FIG. 2 is a schematic overview depicting a communication network 1. The communication network 1 comprises one or more access networks, such as RANs or wired access networks, and one or more CNs. The communication network 1 may use one or a number of different technologies. Embodiments herein relate to recent wired and wireless networks such as Wi-Fi, new radio (NR), other existing wired or wireless networks, and further developments of existing wireless communications systems such as e.g., LTE or WCDMA.

In the communication network 1, a receiver node 10, exemplified herein as a UE, a wireless device such as a mobile station, a non-access point (non-AP) station (STA), a STA and/or a wireless terminal, is comprised communicating via the one or more Access Networks (AN) to other UEs or one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node. The receiver node 10 comprises a receiver with a signal processing capability.

The communication network 1 comprises a transmitter node 12 providing radio coverage over a geographical area, a first service area 11 or first cell, of a first RAT, such as WiFi, NR, LTE, or similar. The transmitter node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point

Station (AP STA), a transmission arrangement of a radio base station, a stand-alone access point or any other network unit or node capable of communicating with a UE within the area served by the radio network node depending e.g. on the first radio access technology and terminology used. The transmitter node 12 may be an access node such as a WiFi-modem or a radio network node and may be referred to as a serving radio network node wherein the service area may be referred to as a serving cell. In cases where a radio network node communicates in form of DL transmissions to the UE, the transmitter node 12 is the radio network node, and in scenarios where UL transmissions from the UE are used to adapt receiver configuration the radio network node is the receiver node 10. It should be noted that a service area may be denoted as cell, beam, beam group or similar to define an area of radio coverage.

According to embodiments herein the transmitter node 12 and/or the receiver node 10 may obtain an estimated signal quality of a signal, an indication of a hardware quality, a status of an energy source associated with the receiver, and/or a target KPI. The transmitter node 12 may then initiate an adaption of the signal processing capability of the receiver of the receiver node 10. For example, the transmitter node 12 may transmit a configuration for the receiver of the receiver node 10. Alternatively, or additionally, the receiver node 10 may adapt the signal processing capability of the receiver based on the obtained estimated signal quality, the indicated hardware quality, the status of the energy source, and/or the target KPI.

In the embodiments described herein the proposed method enables a receiver to adapt its complexity and processing delay to the signal quality, the hardware quality, the status of the energy source, and/or the target KPI. This in its turn may:
increase energy efficiency of the receiver;
reduce the expected processing delay of the received signals; and/or
improve battery lifetime of UEs in downlink scenarios and reduce size and weight of base stations in uplink scenarios.

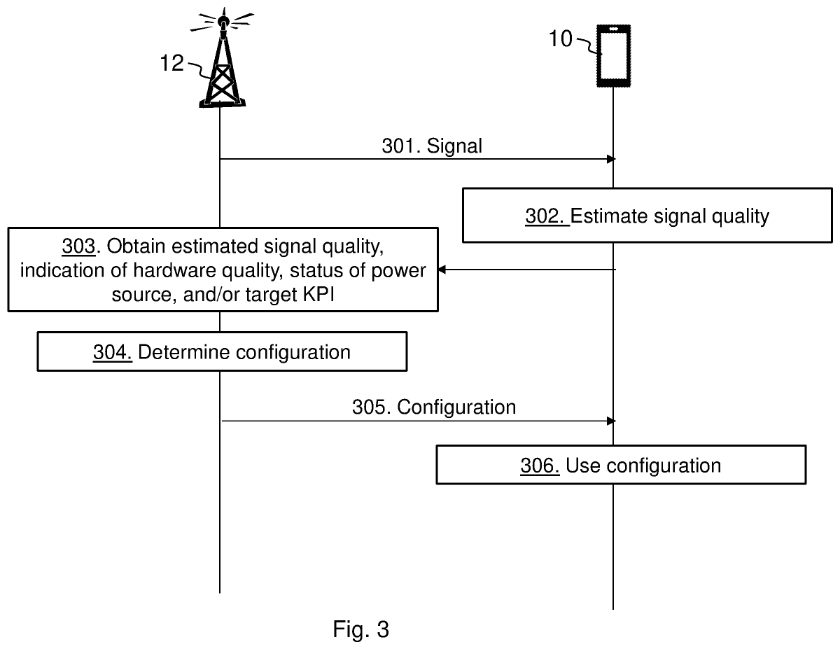

FIG. 3 is a combined signalling and flowchart scheme according to some embodiments herein focusing on the estimated signal quality.

Action 301. The transmitter node 12 may transmit a radio signal to the receiver node 10.

Action 302. The receiver node 10 may measure and/or estimate signal quality of the radio signal.

Action 303. The receiver node 10 may report to the transmitter node 12 the obtained estimated signal quality of the radio signal. Thus, the transmitter node 12 may further obtain one or more of the following: the indication of the hardware quality, the status of the energy source associated with the receiver, and/or the target KPI.

Action 304. The transmitter node 12 may then determine a configuration for the receiver of the receiver node 10 based on the obtained estimated signal quality of the radio signal, the indication of the hardware quality, the status of the energy source associated with the receiver, and/or the target KPI.

Action 305. The transmitter node 12 may further transmit an indication of the configuration or transmit the configuration to the receiver node 10.

Action 306. The receiver node 10 may then use the configuration for the receiver and thus increase energy efficiency of the receiver, reduce the expected processing delay of the received signals, and/or improve battery lifetime of receiver node.

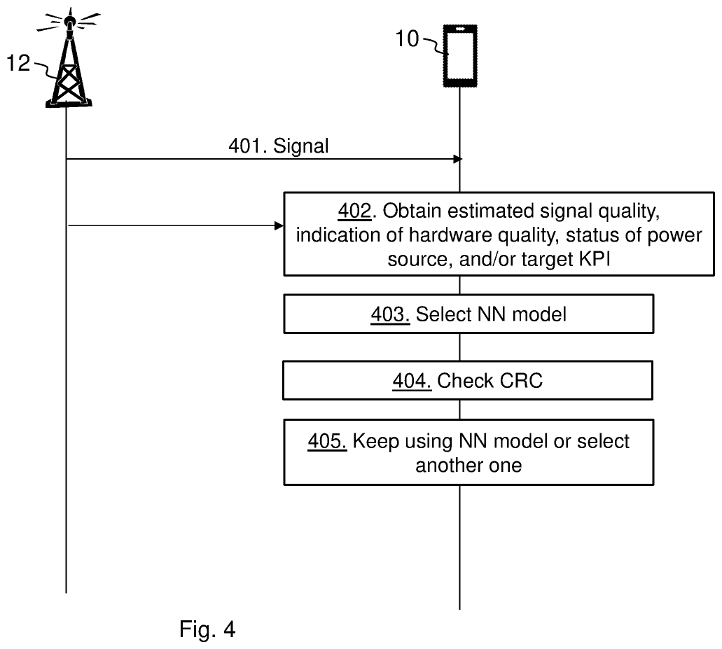

FIG. 4 is a combined signalling and flowchart scheme according to some embodiments herein.

Action 401. The transmitter node 12 may transmit a radio signal to the receiver node 10.

Action 402. The receiver node 10 may obtain one or more of the following: the estimated signal quality of the radio signal, the indication of the hardware quality, the status of the energy source associated with the receiver, and/or the target KPI. For example, the receiver node 10 may measure and/or estimate signal quality of the radio signal, retrieve locally the indication of the hardware quality, the status of the energy source associated with the receiver, and/or the target KPI.

Action 403. The receiver node 10 may then select a neural network (NN) model from a set of neural network models based on the estimated signal quality of the radio signal, the indication of the hardware quality, the status of the energy source associated with the receiver, and/or the target KPI. Thus, the receiver node 10 may adapt the signal processing capability by selecting the NN model out of the number of NN models based on the estimated signal quality, the indicated hardware quality, the status of the energy source, and/or the target KPI.

Action 404. The receiver node 10 may then check a CRC value.

Action 405. The receiver node 10 may, if the CRC check is successful, keep using the initial NN model, and if the CRC check is not successful, the receiver node 10 may use another more complex or capable NN model.

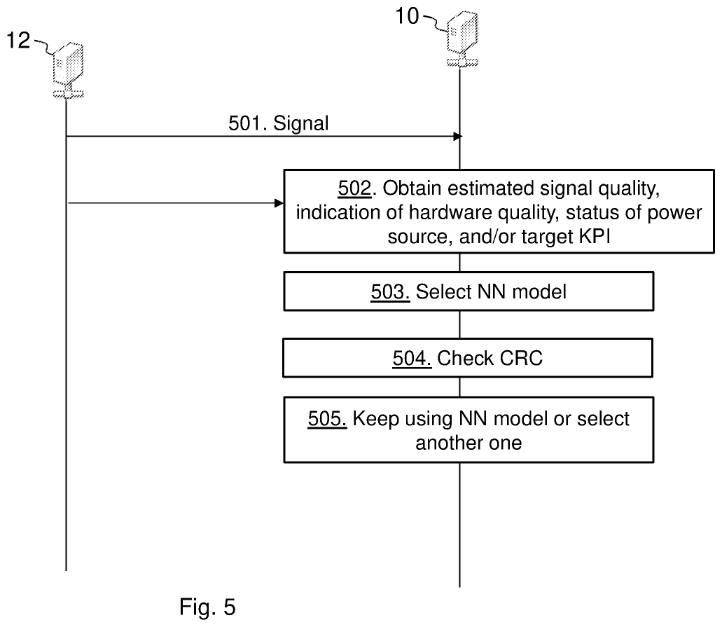

FIG. 5 is a combined signalling and flowchart scheme according to some embodiments herein over a wired connection.

Action 501. The transmitter node 12 may transmit a signal, such as an optical signal, to the receiver node 10.

Action 502. The receiver node 10 may obtain one or more of the following: the estimated signal quality of the signal, the indication of the hardware quality, the status of the energy source associated with the receiver, and/or the target KPI. For example, the receiver node 10 may measure and/or estimate signal quality of the signal, retrieve locally the indication of the hardware quality, the status of the energy source associated with the receiver, and/or the target KPI.

Action 503. The receiver node 10 may then select a NN model from the set of NN models based on the estimated signal quality of the signal, the indication of the hardware quality, the status of the energy source associated with the receiver, and/or the target KPI. Thus, the receiver node 10 may adapt the signal processing capability by selecting the NN model out of the number of NN models based on the estimated signal quality, the indicated hardware quality, the status of the energy source, and/or the target KPI.

Action 504. The receiver node 10 may then check a CRC value.

Action 505. The receiver node 10 may, if the CRC check is successful, keep using the initial NN model, and if the CRC check is not successful, the receiver node 10 may use another more complex or capable NN model.

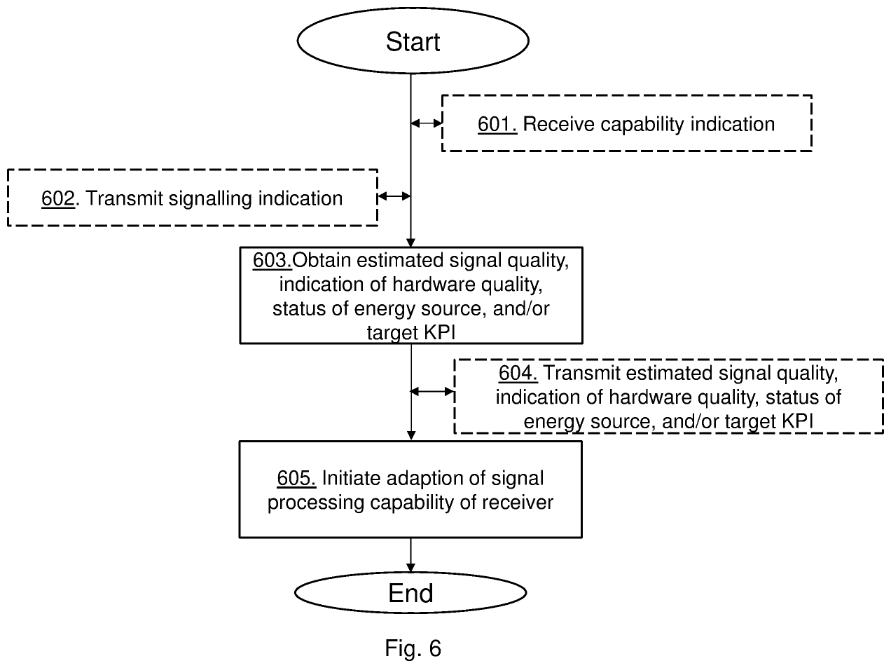

The method actions performed by the transmitter node 12 for adapting a signal processing capability of the receiver of the receiver node 10 in the communication network 1 according to embodiments herein will now be described with reference to a flowchart depicted in FIG. 6. The actions do not have to be taken in the order stated below, but may be taken in any suitable order. Dashed boxes indicate optional features.

Action 601. The transmitter node 12 may receive a capability indication from the receiver node 10, indicating capability of adapting the signal processing capability of the receiver. The capability indication may be represented by a value, an index, a flag or similar.

Action 602. The transmitter node 12 may transmit a signalling indication to the receiver node 10, indicating a capability of transmitting signals to be used for adapting the signal processing capability of the receiver. For example, the transmitter node 12 may be capable of transmitting a reference signal or similar to perform estimation of signal quality. The signalling indication may be represented by a value, an index, a flag or similar.

Action 603. The transmitter node 12 obtains the estimated signal quality of the signal, the indication of the hardware quality, the status of the energy source associated with the receiver, and/or the target KPI. For example, the transmitter node 12 may receive from the receiver node 10 one or more of: the estimated signal quality of the signal, the indication of the hardware quality, the status of the energy source associated with the receiver, and/or the target KPI. Alternatively, or additionally, the transmitter node 12 may measure or retrieve the estimated signal quality of the signal, the indication of the hardware quality, the status of the energy source associated with the receiver, and/or the target KPI, locally and/or from another node.

Action 604. The transmitter node 12 may transmit to the receiver node 10, one or more of: the estimated signal quality of the signal, the indication of the hardware quality, the status of the energy source associated with the receiver, and/or the target KPI. The estimated signal quality of the signal, the indication of the hardware quality, the status of the energy source associated with the receiver, and/or the target KPI may be represented by a value, an index, a flag or similar.

Action 605. The transmitter node 12 further initiates an adaption of the signal processing capability of the receiver based on the estimated signal quality, the indicated hardware quality, the status of the energy source, and/or the target KPI. For example, the transmitter node 12 may initiate the adaption of the signal processing capability by determining a configuration of the signal processing capability for the receiver based on the estimated signal quality, the indicated hardware quality, the status of the energy source, and/or the target KPI. Then, the transmitter node 12 may transmit to the receiver node 10 comprising the receiver, an indication of the determined configuration of the signal processing capability. It should be noted that the signal processing capability may comprise a NN model and adaption of the signal processing capability may comprise adapting the NN model in terms of number of layers, neurons, and/or input parameters. In one example, the transmitter node 12 may initiate the adaption of the signal processing capability by selecting the NN model out of a number of NN models based on the estimated signal quality, the indicated hardware quality, the status of the energy source, and/or the target KPI. The indication of the configuration may be represented by a value, an index, a flag or similar.

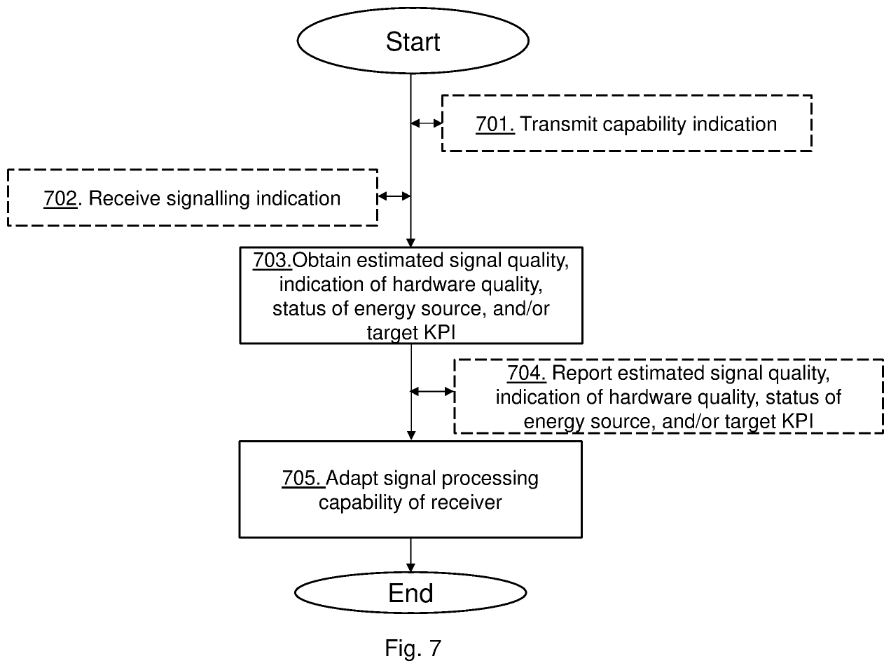

The method actions performed by the receiver node 10 for adapting the signal processing capability of the receiver comprised in the receiver node in the communication network 1 according to embodiments herein will now be described with reference to a flowchart depicted in FIG. 7. The actions do not have to be taken in the order stated below but may be taken in any suitable order. Dashed boxes indicate optional features.

Action 701. The receiver node 10 may transmit to the transmitter node 12 the capability indication indicating capability of adapting the signal processing capability of the receiver. The capability indication may be represented by a value, an index, a flag or similar.

Action 702. The receiver node 10 may receive the signalling indication from the transmitter node 12, indicating the capability of transmitting signals for adapting the signal processing capability of the receiver. The signalling indication may be represented by a value, an index, a flag or similar.

Action 703. The receiver node 10 obtains the estimated signal quality of the signal, the indication of the hardware quality, the status of the energy source associated with the receiver, and/or the target KPI. The receiver node 10 may receive from the transmitter node 12 one or more of: the estimated signal quality of the signal, the indication of the hardware quality, the status of the energy source associated with the receiver, and/or the target KPI. Alternatively, or additionally, the receiver node 10 may measure or retrieve the estimated signal quality of the signal, the indication of the hardware quality, the status of the energy source associated with the receiver, and/or the target KPI, locally and/or from another node.

Action 704. The receiver node 10 may report to the transmitter node 12 one or more of: the obtained estimated signal quality of the signal, the indication of the hardware quality, the status of the energy source associated with the receiver, and/or the target KPI. The estimated signal quality of the signal, the indication of the hardware quality, the status of the energy source associated with the receiver, and/or the target KPI may be represented by a value, an index, a flag or similar.

Action 705. The receiver node 10 adapts the signal processing capability of the receiver based on the estimated signal quality, the indicated hardware quality, the status of the energy source, and/or the target KPI. The signal processing capability may comprise the neural network model and the receiver node 10 may adapt the signal processing capability by adapting the NN model in terms of number of layers, neurons, and/or input parameters. Additionally, or alternatively, the receiver node 10 may adapt the signal processing capability by using an initial NN model and by checking a CRC value. If the CRC check is successful the receiver node 10 may keep using the initial NN model, and if the CRC check is not successful the receiver node 10 may use another NN model, e.g., a more complex or capable NN model. The receiver node 10 may adapt the signal processing capability by selecting a neural network model out of the number of neural network models based on the estimated signal quality, the indicated hardware quality, the status of the energy source, and/or the target KPI. As stated above, the receiver node 10 may adapt the signal processing capability of the receiver by receiving from the transmitter node 12, an indication of a determined configuration of the signal processing capability, and then adapt the signal processing capability according to the received configuration.

It should be noted that the estimated signal quality may be quantified by different measures, e.g. signal-to-noise ratio (SNR) to account for degradations due to noise, signal-to-noise-and interference ratio (SINR) to account for degradation due to noise and interference, signal-to-noise_and distortion ratio (SNDR) to account degradations due to noise and distortions, e.g. due to RF hardware impairments, and signal to interference and noise and distortion ratio (SINDR) to account for degradations due to noise and interference and distortions.

A pre-trained NN model may be selected based on the hardware profile of the transmitter node 12 and the receiver node 10. One network node can request another network node to transmit the parameters of the hardware profile, such as phase noise profile over the air interface. The network node 12 may use the profiles from both side as the input to select the appropriate pre-trained NN model.

The model selection may be updated if the signal quality, e.g., SNR or SNDR, or SINR, or the hardware profile changes, e.g., due to UE mobility, change in the hardware operating conditions, traffic load in the network, or similar. The receiver node 10 may adapt the complexity of the receiver, accordingly. For example, if SNR decreases or phase noise increases, then a more capable NN model may be used in the receiver of the receiver node 10.

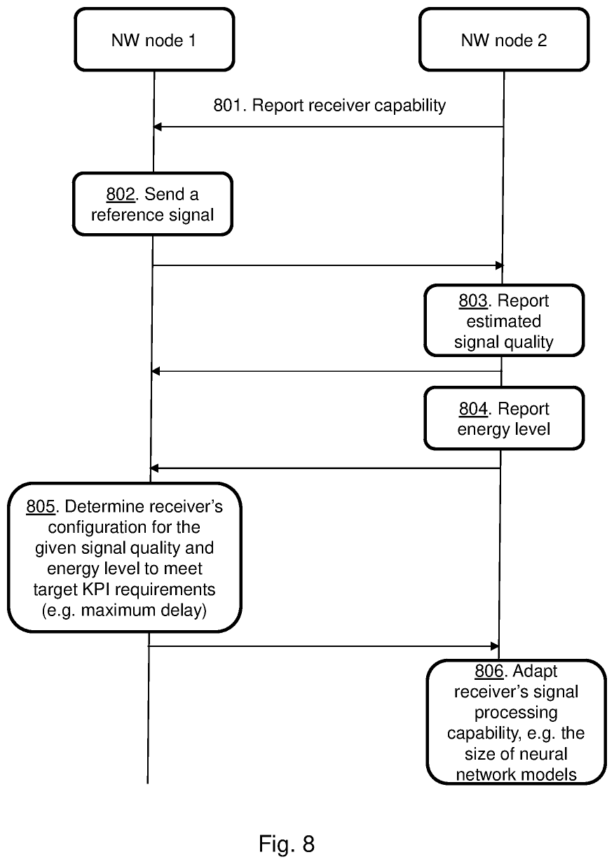

FIG. 8 is a combined flowchart and signalling scheme according to some embodiments herein between a network node (NW) node 1, being an example of the transmitter node 12, and a NW node 2, being an example of the receiver node 10.

Action 801. The receiver node 10 may report receiver capability of NN processing. For example, the NW 2 may report the capability indication.

Action 802. The transmitter node 12 may send a reference signal.

Action 803. The receiver node 10 may estimate the signal quality and may report estimated signal quality.

Action 804. The receiver node 10 may further report energy level of the energy source, such as a level of a battery.

Action 805. The transmitter node 12 may then determine receiver's configuration for the given signal quality and energy level to meet target KPI requirements, e.g., maximum delay.

Action 806. The receiver node 10 may then adapt receiver's capability, e.g., the size of the NN model, based on the received configuration.

FIG. 8 is an example implementation of the method with receiver capability selection at transmitter node 12.

Embodiments herein may be implemented based on the following procedure in transmitter node 12 and the receiver node 10.

Capability reporting: The receiver node 10 may report the capability to perform adaptive signal processing, e.g., using artificial NNs with multiple levels of complexity. The transmitter node 12 in its turn may report capability to send a reference signal for the received signal quality estimation.

Network procedure and signalling:

The transmitter node 12 may send a reference signal for the received signal quality estimation. The receiver node 10 may then estimate signal quality, using metrics such as SNR, SNDR, SINR, SINDR, and report the estimated signal quality to the transmitter node 12. The receiver node 10 may further report to the transmitter node 12, its hardware profile parameters, e.g., phase noise power, and may report an estimate of the available energy level, e.g., battery level of a UE or the percentage of the available battery in downlink scenario, of the receiver node 10.

The transmitter node 12 may then determine the receiver configuration based on the estimated received signal quality, available energy level, hardware profile and the target KPI, where the configuration may be the NN model to be used, or the depth of a NN model, in terms of number of layers, neurons, and/or input parameters, to be selected.

The transmitter node 12 may further send the receiver configuration to the receiver node 10. The receiver configuration may be sent using e.g., downlink control information (DCI) or uplink control information (UCI) signalling depending on whether the method is applied in downlink or uplink scenario. The receiver configuration may be the NN model to be used, or the depth of a NN model to be selected, the architecture, and size of the NNs, e.g., number of neurons and the number of different layers of the network. This NN model may be used for initializing the processing at the receiver, and the complexity of the NN model may be adjusted iteratively at the receiver.

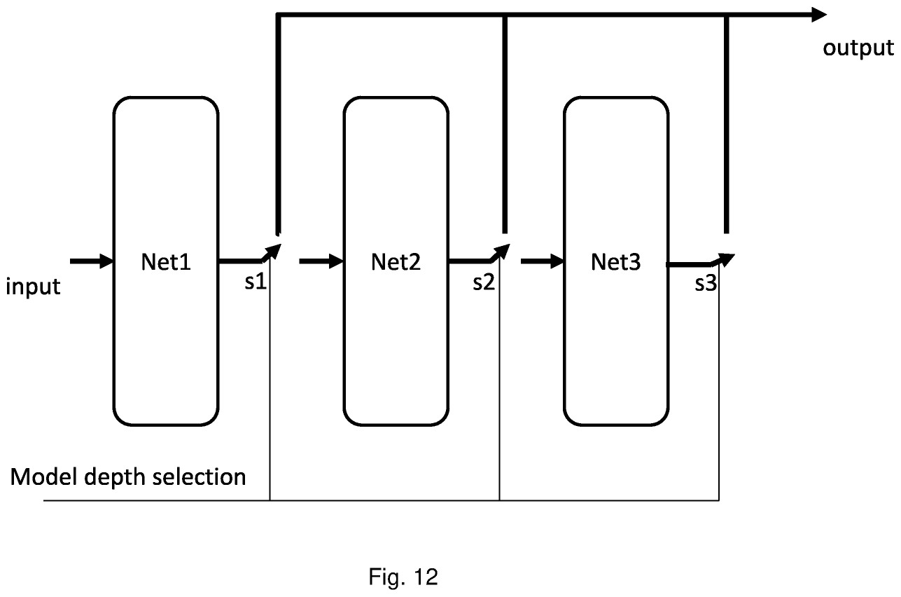

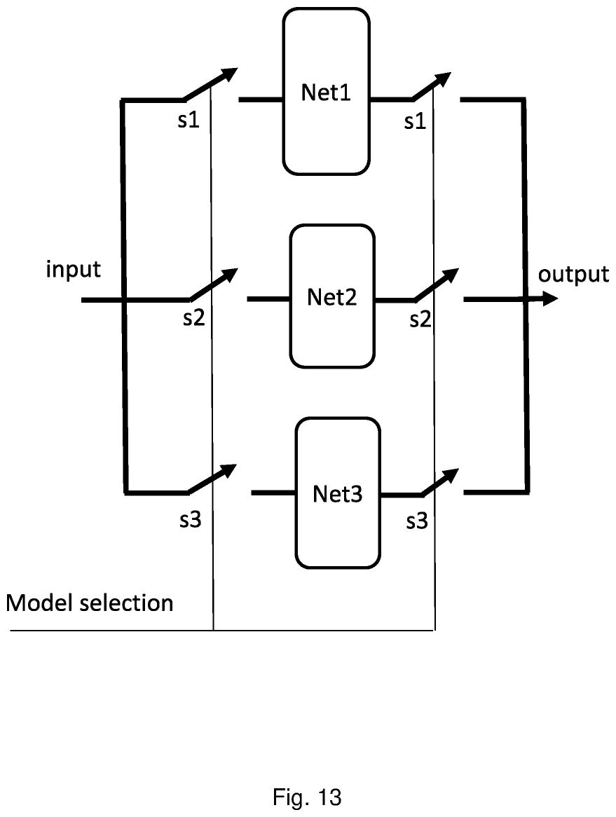

The receiver node 10 may then adapt the receiver signal processing method, e.g. the ML demapper, according to the recommended receiver configuration, e.g. by selecting the recommended NN model, see FIG. 13, or selecting the depth of an adaptive depth NN, see FIG. 12. The receiver node 10 may iteratively check the CRC and if it fails, the receiver node 10 may increase the capability of the receiver by using a more capable NN model.

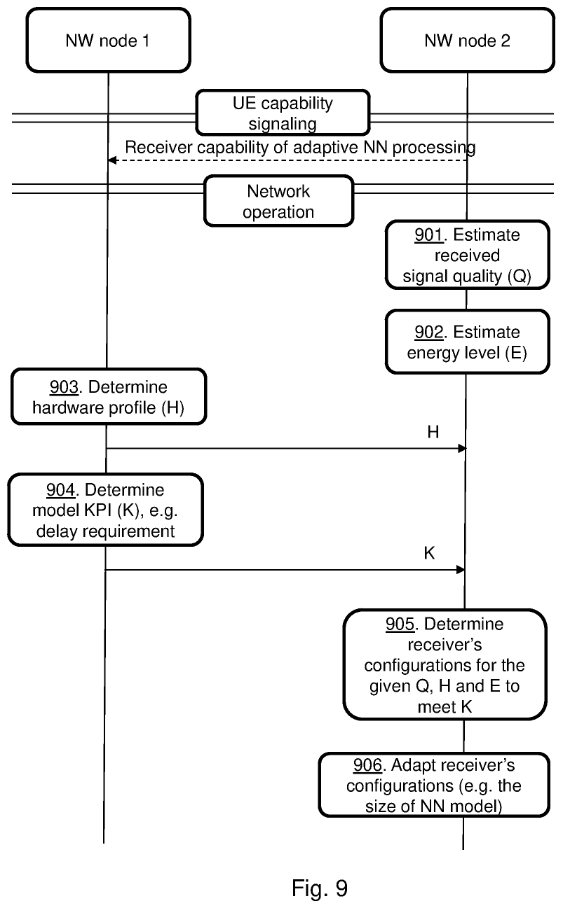

FIG. 9 is a combined flowchart and signalling scheme according to some embodiments herein between a NW node 1, being an example of the transmitter node 12, and a NW node 2, being an example of the receiver node 10. In the example of FIG. 9, the following procedure in the transmitter node 12 and the receiver node 10 may be performed:

A UE capability signalling is performed. The receiver node 10 transmits the receiver capability of adaptive NN processing.

A network operation may then be performed as follows:

The transmitter node 12 may send a reference signal for the received signal quality estimation. The receiver node 10 may estimate received signal quality, see action 901. The receiver node 10 may estimate signal quality, using metrics such as SNR, SNDR, SINR, SINDR, and may report the estimated signal quality to the transmitter node 12. The receiver node 10 may further estimate energy level of the energy source such as a battery, see action 902.

The transmitter node 12 may determine the hardware profile of the receiver and/or a transmitter of the transmitter node 12, see action 903. The transmitter node 12 may then transmit indication of the determined hardware profile to the receiver node 10. The transmitter node 12 may send the parameters of the hardware profile (H), e.g. the transmitter phase noise power.

The transmitter node 12 may determine model KPI, e.g., delay requirement, see action 904. The transmitter node 12 may then transmit indication of the determined model KPI to the receiver node 10. The transmitter node 12 may, for example, send the KPI requirements (K) to be satisfied, where the KPIs can be the maximum allowed processing delay at the receiver node 10.

The receiver node 10 may then determine, see action 905, receiver's configuration for the given signal quality, energy level, hardware profile to meet target KPI requirements, e.g., meet the delay requirement. The receiver node 10 may determine the receiver configuration based on the estimated received signal quality, available energy level, and the target KPI, where the configuration can be the neural network model to be used, or the depth of a neural network model to be selected.

The receiver node 10 then adapts receiver's configuration, e.g., the size of the NN model, see action 906. The receiver node 10 may adapt the receiver signal processing method, e.g., the ML demapper, according to the recommended configuration, e.g., by loading and using the recommended neural network model, see FIG. 13, or by selecting the depth of a stochastic depth NN, see FIG. 12.

Thus, it is herein disclosed an example implementation of the method with receiver capability selection at the receiver node 10.

As stated above, the transmitter node 12 may report the capability to send a reference signal for the received signal quality estimation.

The proposed method may require one or more of the following:
A signal from the receiver node 10 to the transmitter node 12 to report the energy status.
A signal from one node to another node to report a hardware profile of the receiver node 10.
A signal from the transmitter node 12 to the receiver node 10 to configure the signal processing capability, for example, ML or Al model, of the receiver.
A signal from the transmitter node 12 to the receiver node 10 to set the target KPI requirements.
Reporting a capability indication for the receiver's adaptive NN processing.

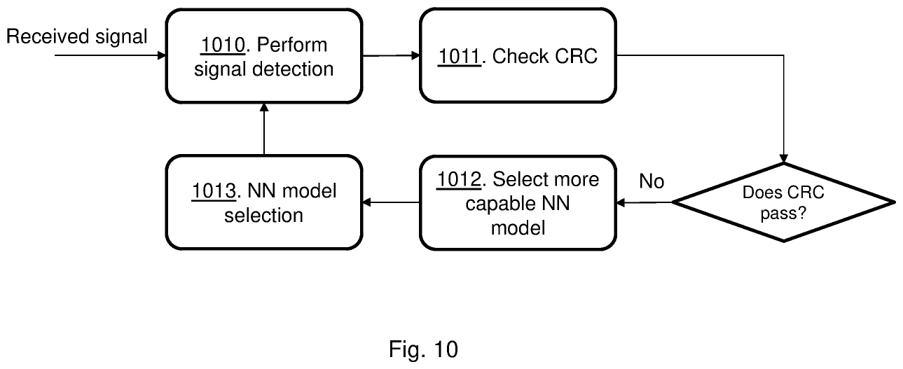

FIG. 10 is a schematic overview depicting a method performed in the receiver node 10. The receiver node 10 may perform signal detection, action 1010, select a NN model and check a CRC value, action 1011. If the CRC value does not pass, the receiver node 10 may select a more capable NN model, action 1012, and may perform a NN model selection, action 1013.

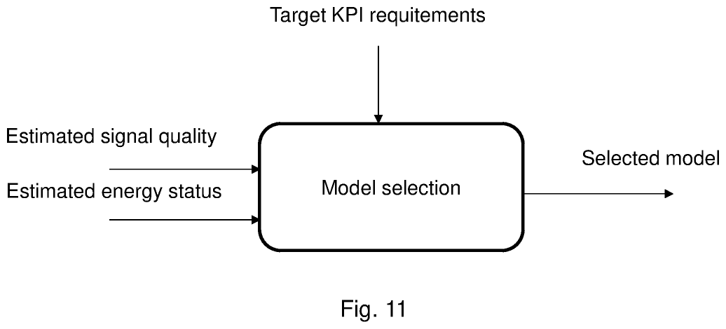

FIG. 11 shows a schematic NN model selection procedure.

The NN model selection may be a parameterized model in itself, with parameters being trainable to fulfil a target performance.

Alternatively, or additionally, a table, or a function may be constructed in which each specific NN model, wherein the notion of NN model includes also a selected subset of layers in a larger model, as in the case of for example training a model with adaptive depth, may be associated to a certain estimated signal quality, hardware profile, estimated energy level at receiver, and/or the target KPI, e.g., a desired processing delay. Next, based on the estimated signal quality, hardware profile, estimated energy level, and the target KPI, appropriate neural network model or the neural network model depth may be selected as shown in FIG. 11. The entries of the table may be updated based on the performance of the selected NN models under a certain working condition.

According to some embodiments herein, a NN with adaptive depth may be used, where the number of layers that are used for processing of the received signal can be adapted according to the received signal quality as shown in FIG. 12. A NN with an adaptive depth may be trained such as if one drops out the last K layers, where K is a random number between 0 and N, and the output of the N−K+1 layer may be used for inference. This would have the effect that any layer may act as output layer. During inference, the input may then be fed through the set of first layer(s), selected by the model selection, and check a CRC. If the CRC fails, the output may be taken from the first set of layer(s) (s1) and may then be fed through the next set of layer(s) etc.

FIG. 12 shows a pre-trained NN architecture with adaptive depth, where the depth can be adapted to the required processing capability at a network node. In this example, a main NN composed of concatenation of three NNs Net1, Net2, and Net3 is illustrated, where each of the NNs Net1, Net2, Net3 may be composed of a simple single layer of neurons or be a more complex NN. There are switches s1, s2, and s3 that may receive a command on model depth selection and function as follows. If s1=on, the outputs of Net1 will pass as the inputs to Net2, and if s1=off the outputs of Net1 will be passed as the outputs of the main NN. If s1=non then the output of the Net1 is not used and hence Net1 can be turned off. This can be extended to s2, and s3. The switches may have the following possibilities:
1) s1=on, s2=on, s3=off: main NN composed of Net1, Net2, Net3
2) S1=on, s2=off, s3=non: main NN is composed of Net1, and Net2
3) S1=off, s2=non, s3=non: main NN is composed of Net1
This can be extended to the case with K NNs Net1, Net2, . . . , NetK.

A NN may be trained where the output of each layer, or the set of layers used by the model selection module, is trained against a target, e.g., an explicit label, or reconstruction of input. This may effectively create a set of loss values, one per each output, that may be weighted to construct a final loss function used in updating the model parameters. During inference, the input may be fed through the set of first layer(s), selected by the model selection, and a CRC value may be checked. If the CRC fails the output from the first layer (s1) may be fed through the next set of layer(s) etc. This differs in how the NN model is trained compared to the embodiment using a stochastic depth but once trained the same architecture in FIG. 12 may be applied.

It is herein disclosed a method to adapt the receiver's signal processing capability, e.g., the size of a NN model, and hence the complexity of signal processing according to: the estimated signal quality, for example, measured using e.g. SNR, SINR, or SINDR; the hardware profile, e.g., phase noise power; and/or estimated receiver's energy status that fulfil the target KPI, e.g., the processing delay.

The signal processing capability may be adapted, for example, by modifying the size of a NN, e.g., the number of layers and/or neurons, in an ML/AI-based receiver, e.g., a receiver with a neural network-based demapper (NN-demapper).

In one example, a set of ‘N’ NN models may be pre-trained each with a given capability and complexity, i.e., model #i, complexity =C_i, i∈{1, . . . ,N}, where C_1<C_2< . . . <C_N, as shown in FIG. 13. Next, select the model with lowest complexity which is sufficient for signal detection using, e.g., the procedure as shown in FIG. 10. In FIG. 13, an example with N=3 is shown with three NN models Net1, Net2, and Net3, where Net1 has the lowest complexity/capability and Net3 has the highest complexity/capability. The switches s1, s2, and s3 determines which of these NNs to be selected as follows. If s1=on, s2=off, s3=off, then Net1 is selected. If s1=off, s2=on, s3=off, then Net2 is selected. If s1=off, s2=off, s3=on, then Net3 is selected.

Select a model (model #i) based on the estimated signal quality, hardware quality, and receiver's energy status. A table or a function can be used to select a model that is suitable for a given signal quality, hardware quality, and energy status.

Load model #i to the NN-demapper, and check if a CRC can be successfully decoded, and continue as follows depending on the outcome:

If CRC can be decoded, then proceed with the decoded signal,

else load a model with higher complexity (e.g., model #i+1) and check the CRC again.

Continue this procedure and gradually increase the complexity of the model if needed until the CRC can be successfully decoded.

FIG. 13 shows a set of pre-trained neural network models to be selected for signal processing at a receiver node.

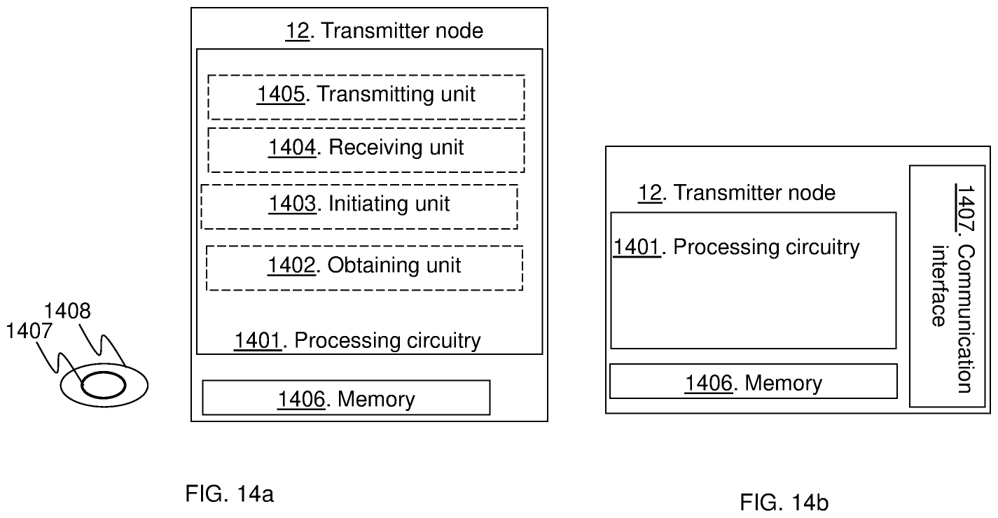

FIGS. 14a-b are schematic overviews of the transmitter node 12 for adapting the signal processing capability of the receiver of the receiver node 10 in the communication network 1 according to embodiments herein.

The transmitter node 12 may comprise processing circuitry 1401, e.g., one or more processors, configured to perform the methods herein.

The transmitter node 12 may comprise an obtaining unit 1402, e.g. a reader, a receiver or a transceiver. The transmitter node 12, the processing circuitry 1401 and/or the obtaining unit 1402 is configured to obtain the estimated signal quality of the signal, the indication of the hardware quality, the status of the energy source associated with the receiver, and/or the target KPI. The transmitter node 12, the processing circuitry 1401 and/or the obtaining unit 1402 may be configured to obtain by receiving from the transmitter node one or more of: the estimated signal quality of the signal, the indication of the hardware quality, the status of the energy source associated with the receiver, and/or the target KPI.

The transmitter node 12 may comprise an initiating unit 1403, for example a configurator, a transmitter, transceiver or similar. The transmitter node 12, the processing circuitry 1401 and/or the initiating unit 1403 is configured to initiate the adaption of the signal processing capability of the receiver based on the estimated signal quality, the indicated hardware quality, the status of the energy source, and/or the target KPI. The transmitter node 12, the processing circuitry 1401 and/or the initiating unit 1403 may be configured to initiate the adaption of the signal processing capability by determining a configuration of the signal processing capability for the receiver based on the estimated signal quality, the indicated hardware quality, the status of the energy source, and/or the target KPI, and further by transmitting to the receiver node 13 comprising the receiver, the indication of the determined configuration of the signal processing capability. The indication may be the configuration or an index of the configuration.

The signal processing capability may comprise a neural network model and adaption of the signal processing capability may comprise adapting the neural network model in terms of number of layers, neurons, and/or input parameters. The transmitter node 12, the processing circuitry 1401 and/or the initiating unit 1403 may be configured to initiate the adaption of the signal processing capability by selecting a neural network model out of the number of neural network models based on the estimated signal quality, the indicated hardware quality, the status of the energy source, and/or the target KPI.

The transmitter node 12 may comprise a receiving unit 1404, e.g., a receiver or a transceiver. The transmitter node 12, the processing circuitry 1401 and/or the receiving unit 1404 may be configured to receive the capability indication from the receiver node 10, indicating capability of adapting the signal processing capability of the receiver.

The transmitter node 12 may comprise a transmitting unit 1405, e.g., a transmitter or a transceiver. The transmitter node 12, the processing circuitry 1401 and/or the transmitting unit 1405 may be configured to transmit the signalling indication to the receiver node 10, indicating capability of transmitting signals for adapting the signal processing capability of the receiver. The transmitter node 12, the processing circuitry 1401 and/or the transmitting unit 1405 may be configured to transmit to the receiver node, one or more of: the estimated signal quality of the signal, the indication of the hardware quality, the status of the energy source associated with the receiver, and/or the target KPI.

The transmitter node 12 may comprise a memory 1406. The memory 1406 comprises one or more units to be used to store data on, such as data packets, grants, parameter(s), indices, configuration, indications, the estimated signal quality, the indicated hardware quality, the status of the energy source, the target KPI, measurements, events and applications to perform the methods disclosed herein when being executed, and similar. Furthermore, the transmitter node 12 may comprise a communication interface 1407, see FIG. 14b, such as comprising a transmitter, a receiver, a transceiver and/or one or more antennas.

The methods according to the embodiments described herein for the transmitter node 12 are respectively implemented by means of e.g., a computer program product 1408 or a computer program, see FIG. 14a, comprising instructions, i.e., software code portions, which, when executed on at least one processor, cause the at least one processor to carry out the actions described herein, as performed by the transmitter node 12. The computer program product 1408 may be stored on a computer-readable storage medium 1409, see FIG. 14a, e.g., a disc, a universal serial bus (USB) stick or similar. The computer-readable storage medium 1409, having stored thereon the computer program product, may comprise the instructions which, when executed on at least one processor, cause the at least one processor to carry out the actions described herein, as performed by the transmitter node 12. In some embodiments, the computer-readable storage medium may be a transitory or a non-transitory computer-readable storage medium. Thus, embodiments herein may disclose a transmitter node 12 for adapting the signal processing capability of the receiver of the receiver node 10 in the communication network, wherein the transmitter node 12 comprises processing circuitry and a memory, said memory comprising instructions executable by said processing circuitry whereby said transmitter node 12 is operative to perform any of the methods herein.

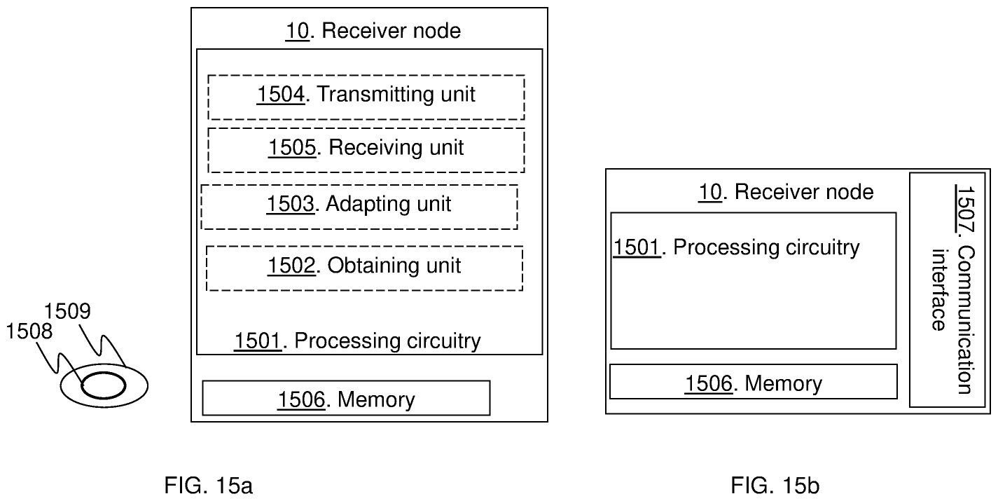

FIGS. 15a-b are schematic overviews of the receiver node 10 for adapting the signal processing capability of the receiver comprised in the receiver node 10 in the communication network 1 according to embodiments herein.

The receiver node 10 may comprise processing circuitry 1501, e.g., one or more processors, configured to perform the methods herein.

The receiver node 10 may comprise an obtaining unit 1502, e.g., a reader, a receiver or transceiver. The receiver node 10, the processing circuitry 1501, and/or the obtaining unit 1502 is configured to obtain the estimated signal quality of the signal, the indication of the hardware quality, the status of the energy source associated with the receiver, and/or the target KPI. The receiver node 10, the processing circuitry 1501, and/or the obtaining unit 1502 may be configured to obtain by receiving from the transmitter node one or more of: the estimated signal quality of the signal, the indication of the hardware quality, the status of the energy source associated with the receiver, and/or the target KPI.

The receiver node 10 may comprise an adapting unit 1503, e.g., a neural network model selector or initiator. The receiver node 10, the processing circuitry 1501, and/or the adapting unit 1503 is configured to adapt the signal processing capability of the receiver based on the estimated signal quality, the indicated hardware quality, the status of the energy source, and/or the target KPI.

It should be noted that the signal processing capability may comprise a neural network model and adapting the signal processing capability may comprise adapting the neural network model in terms of number of layers, neurons, and/or input parameters.

The receiver node 10, the processing circuitry 1501, and/or the adapting unit 1503 may be configured to adapt the signal processing capability by using an initial neural network model and checking CRC value. If the CRC check is successful, the receiver node 10, the processing circuitry 1501, and/or the adapting unit 1503 may be configured to keep using the initial neural network model, and if the CRC check is not successful, the receiver node 10, the processing circuitry 1501, and/or the adapting unit 1503 may be configured to use another more complex NN model.

The receiver node 10, the processing circuitry 1501, and/or the adapting unit 1503 may be configured to adapt the signal processing capability by selecting a NN model out of the number of NN models based on the estimated signal quality, the indicated hardware quality, the status of the energy source, and/or the target KPI.

The receiver node 10 may comprise a transmitting unit 1504, e.g., a transmitter, or transceiver. The receiver node 10, the processing circuitry 1501, and/or the transmitting unit 1504 may be configured to transmit to the transmitter node, the capability indication indicating capability of adapting the signal processing capability of the receiver.

The receiver node 10 may comprise a receiving unit 1505, e.g., the receiver, or transceiver. The receiver node 10, the processing circuitry 1501, and/or the receiving unit 1505 may be configured to receive the signalling indication from the transmitter node 12, indicating capability of transmitting signals for adapting the signal processing capability of the receiver.

The receiver node 10, the processing circuitry 1501, and/or the transmitting unit 1504 may be configured to report to the transmitter node 12 one or more of: the obtained estimated signal quality of the signal, the indication of the hardware quality, the status of the energy source associated with the receiver, and/or the target KPI.

The receiver node 10 may comprise a memory 1506. The memory 1506 comprises one or more units to be used to store data on, such as data packets, grants, parameter(s), indices, configuration, indications, the estimated signal quality, the indicated hardware quality, the status of the energy source, the target KPI, measurements, events and applications to perform the methods disclosed herein when being executed, and similar. Furthermore, the receiver node 10 may comprise a communication interface 1507, see FIG. 15b, such as comprising a transmitter, a receiver, a transceiver and/or one or more antennas.

The methods according to the embodiments described herein for the receiver node 10 are respectively implemented by means of e.g. a computer program product 1508 or a computer program, see FIG. 15a, comprising instructions, i.e., software code portions, which, when executed on at least one processor, cause the at least one processor to carry out the actions described herein, as performed by the receiver node 10. The computer program product 1508 may be stored on a computer-readable storage medium 1509, see FIG. 15a, e.g. a disc, a universal serial bus (USB) stick or similar. The computer-readable storage medium 1509, having stored thereon the computer program product, may comprise the instructions which, when executed on at least one processor, cause the at least one processor to carry out the actions described herein, as performed by the receiver node 10. In some embodiments, the computer-readable storage medium may be a transitory or a non-transitory computer-readable storage medium. Thus, embodiments herein may disclose a receiver node 10 for adapting the signal processing capability of the receiver comprised in the receiver node in the communication network, wherein the receiver node 10 comprises processing circuitry and a memory, said memory comprising instructions executable by said processing circuitry whereby said receiver node 10 is operative to perform any of the methods herein.

In some embodiments a more general term “node” is used and it can correspond to any type of radio-network node or any network node, which communicates with a wireless device, wired device and/or with another network node. Examples of network nodes are, router, modem, server, UE, NodeB, master (M)eNB, secondary (S)eNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), internet of things capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

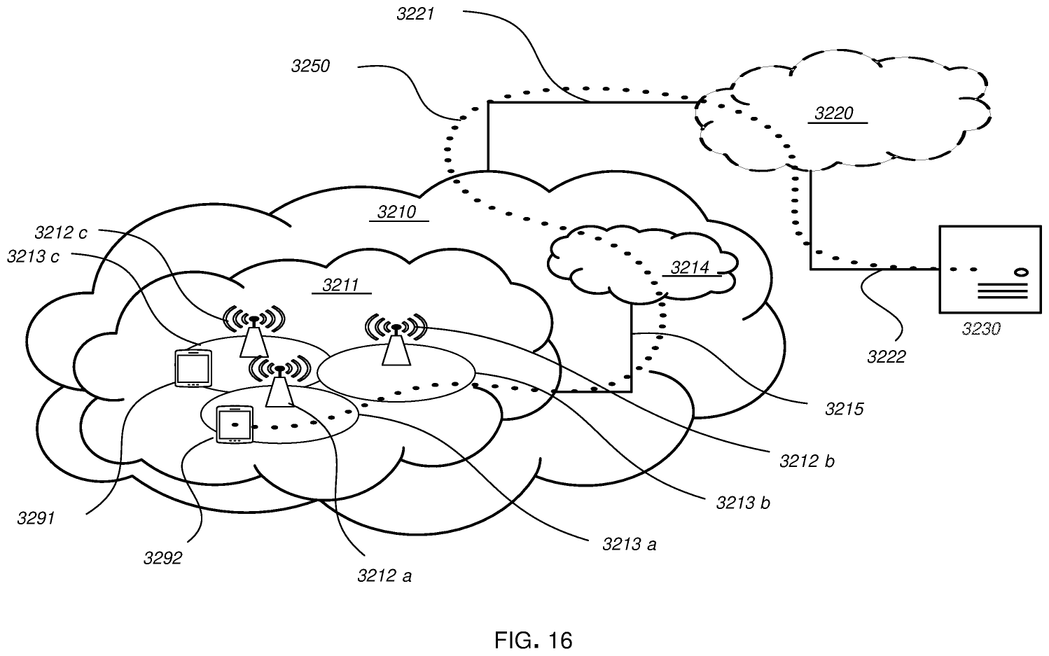

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the receiver/transmitter node herein, each defining a corresponding coverage area 3213a, 3213b, 3213c. Each base station 3212a, 3212b, 3212c is connectable to the core network 3214 over a wired or wireless connection 3215. A first UE 3291, being an example of the receiver/transmitter node, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

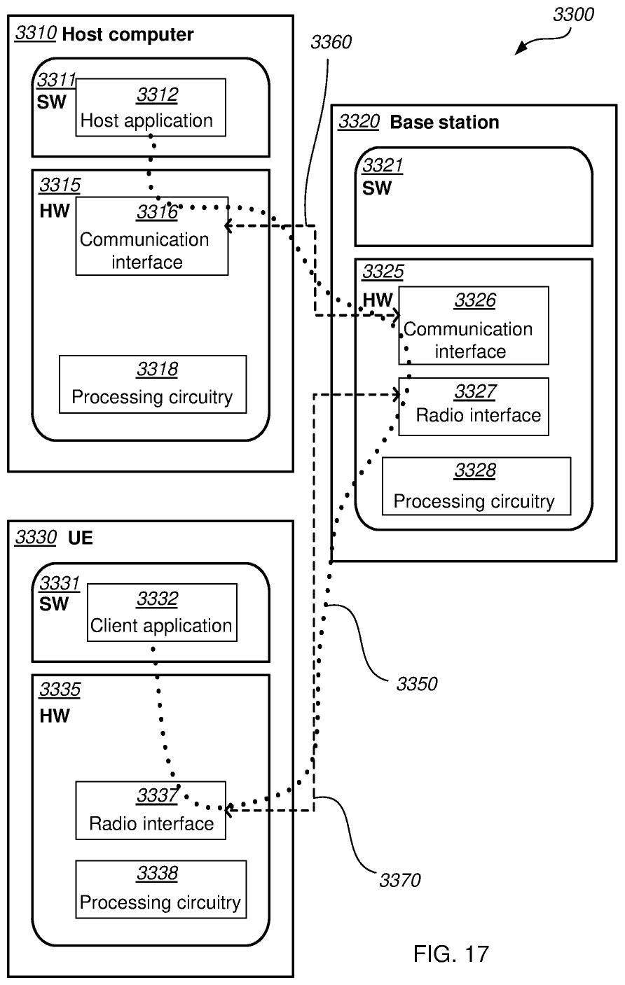

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the signal processing capability is adapted and thereby provide benefits such as improved efficiency and/or reduced cost in the receiver node, and may lead to better performance such as responsiveness and/or battery time of the receiver node.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

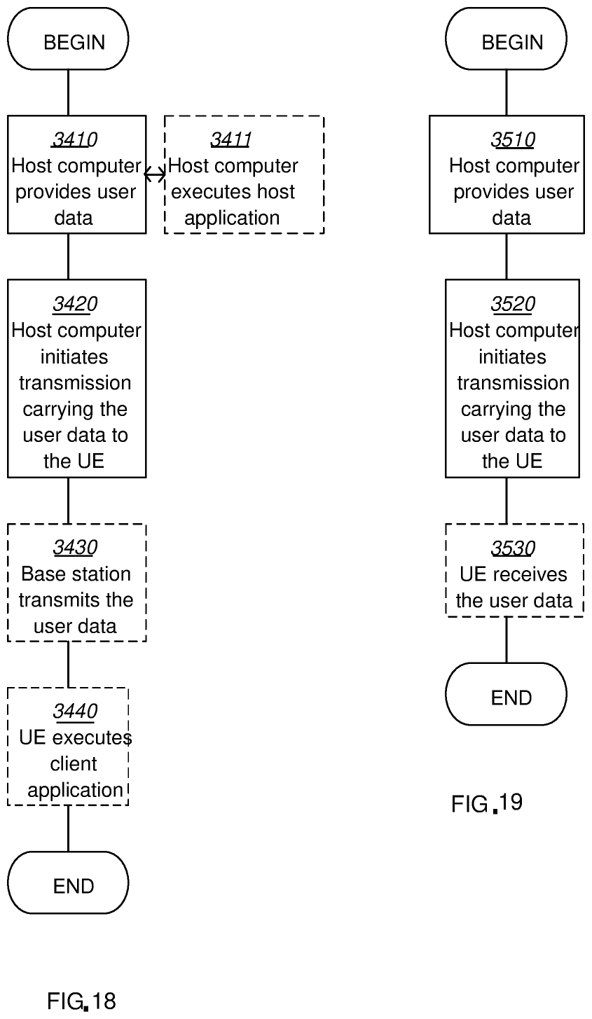

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

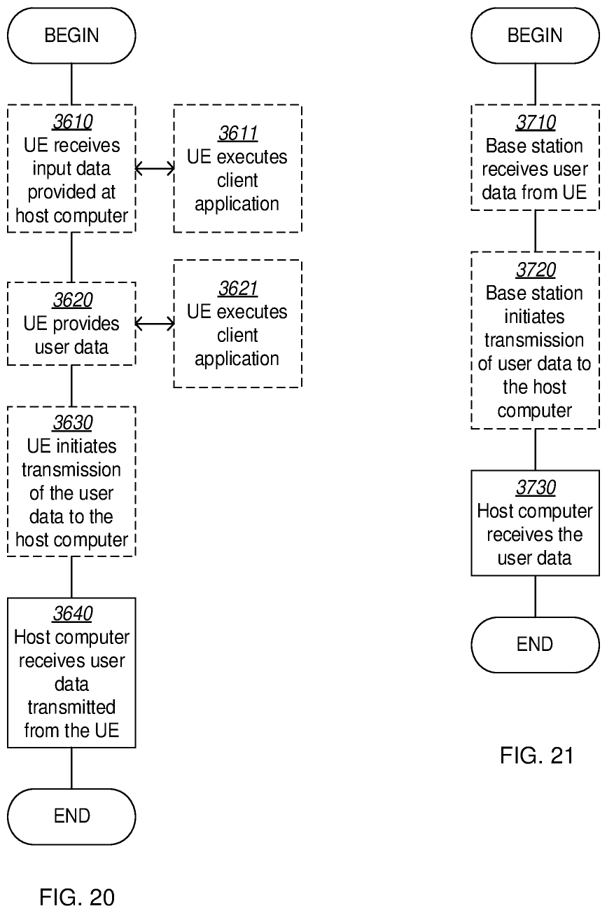

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-34. (canceled)

35. A method performed by a transmitter node for adapting a signal processing capability of a receiver of a receiver node in a communication network, the method comprising
obtaining information comprising at least one of: an estimated signal quality of a signal; an indication of a hardware quality; a status of an energy source associated with the receiver; or a target key performance indicator (KPI); and
initiating an adaption of the signal processing capability of the receiver based on the information.

36. The method according to claim 34, wherein initiating the adaption of the signal processing capability comprises determining a configuration of the signal processing capability for the receiver based on the information, and transmitting to the receiver node comprising the receiver, an indication of the determined configuration of the signal processing capability.

37. The method according to claim 34, wherein the signal processing capability comprises a neural network model and adaption of the signal processing capability comprises adapting the neural network model in terms of one or more of: number of layers; neurons; or input parameters.

38. The method according to claim 34, wherein initiating the adaption of the signal processing capability comprises selecting a neural network model out of a number of neural network models based on the information.

39. The method according to claim 34, further comprising:
receiving a capability indication from the receiver node, indicating a capability of adapting the signal processing capability of the receiver.

40. The method according to claim 34, further comprising:
transmitting a signalling indication to the receiver node, indicating a capability of transmitting signals to be used for adapting the signal processing capability of the receiver.

41. The method according to claim 34, wherein obtaining the information comprises receiving from the receiver node one or more of: the estimated signal quality of the signal, the indication of the hardware quality, the status of the energy source associated with the receiver, or the target KPI.

42. The method according to claim 34, further comprising:
transmitting to the receiver node, one or more of: the estimated signal quality of the signal, the indication of the hardware quality, the status of the energy source associated with the receiver, or the target KPI.

43. A method performed by a receiver node for adapting a signal processing capability of a receiver comprised in the receiver node in a communication network, the method comprising
obtaining information comprising one or more of: an estimated signal quality of a signal; an indication of a hardware quality; a status of an energy source associated with the receiver; or a target key performance indicator (KPI); and
adapting the signal processing capability of the receiver based on the information.

44. The method according to claim 43, wherein the signal processing capability comprises a neural network model and adapting the signal processing capability comprises adapting the neural network model in terms of one or more of: number of layers; neurons; or input parameters.

45. The method according to claim 43, wherein adapting the signal processing capability comprises using an initial neural network model and checking a cyclic redundancy check (CRC) value, if the CRC check is successful, keep using the initial neural network model, and if the CRC check is not successful, use another more complex neural network model.

46. The method according to claim 43, wherein adapting the signal processing capability comprises selecting a neural network model out of a number of neural network models based on the information.

47. The method according to claim 43, further comprising:
transmitting to a transmitter node, a capability indication indicating capability of adapting the signal processing capability of the receiver.

48. The method according to claim 43, further comprising:
receiving a signalling indication from a transmitter node, indicating capability of transmitting signals for adapting the signal processing capability of the receiver.

49. The method according to claim 43, further comprising:
reporting to a transmitter node one or more of: the obtained estimated signal quality of the signal, the indication of the hardware quality, the status of the energy source associated with the receiver, or the target KPI.

50. The method according to claim 43, wherein obtaining the information comprises receiving from a transmitter node one or more of: the estimated signal quality of the signal, the indication of the hardware quality, the status of the energy source associated with the receiver, or the target KPI.

51. A transmitter node for adapting a signal processing capability of a receiver of a receiver node in a communication network, wherein the transmitter node comprises:
circuitry configured to obtain information comprising one or more of: an estimated signal quality of a signal; an indication of a hardware quality; a status of an energy source associated with the receiver; or a target key performance indicator (KPI); and
circuitry configured to initiate an adaption of the signal processing capability of the receiver based on the information.

52. A receiver node for adapting a signal processing capability of a receiver comprised in the receiver node in a communication network, wherein the receiver node comprises:
circuitry configured to obtain information comprising one or more of: an estimated signal quality of a signal; an indication of a hardware quality; a status of an energy source associated with the receiver; or a target key performance indicator (KPI); and
circuitry configured to adapt the signal processing capability of the receiver based on the information.

53. The receiver node according to claim 52, wherein the signal processing capability comprises a neural network model and adapting the signal processing capability comprises adapting the neural network model in terms of one or more of: number of layers; neurons; or input parameters.

54. The receiver node according to claim 52, wherein the circuitry configured to adapt the signal processing capability is configured to control the receiver node to use an initial neural network model, and is further configured to check a cyclic redundancy check (CRC) value, and control the receiver node to use a more complex neural network mode responsive to the CRC not being successful.
